(19) United States
(12) Patent Application Publication
(10) Pub. No.: US 2022/0259704 A1
(43) Pub. Date: Aug. 18, 2022

(54) LONG-LIFE ALUMINUM ALLOY WITH A HIGH CORROSION RESISTANCE AND HELICALLY GROOVED TUBE PRODUCED FROM THE ALLOY

(71) Applicant: HYDRO PRECISION TUBING (SUZHOU) CO., Ltd, Suzhou (CN)

(72) Inventors: Minxia LI, Suzhou (CN); Arvid ESPEDAL, Mårslet (DK); Nagaraj V. GOVINDARAJ, Tønder (DK); Ole Johannes EMMERHOFF, Torvastad (NO); Guo PINGCHUANG, Suzhou (CN); Jinghui SU, Suzhou (CN); Hongping XU, Suzhou (CN)

(21) Appl. No.: 17/626,748

(22) PCT Filed: Nov. 21, 2019
(86) PCT No.: PCT/IB2019/060038

§ 371 Date: Jan. 12, 2022

(30) Foreign Application Priority Data
Jul. 22, 2019 (CN) 201910661744.0

(51) Int. Cl. C22C 21/16; F28F 1/40; F28F 21/08; C22C 30/06; C22C 30/02

(52) U.S. Cl. CPC C22C 21/16; F28F 1/40; B21C 23/002; C22C 30/06; C22C 30/02; F28F 21/084

(57) ABSTRACT

An aluminium alloy including 1.0-1.5 wt % Mn, up to 0.1 wt % Mg, up to 0.3 wt % Si, up to 0.3 wt % Fe, up to 0.1 wt % Cu, up to 0.25 wt % Cr, up to 0.1 wt % Ni, up to 0.3 wt % Zn, up to 0.1% Ti, up to 0.2 Zr. The allow also includes impurities, each no more than 0.05 wt. % and wherein the total of impurities is no more than 0.15 wt. %, with the balance being aluminum.

### CROSS-REFERENCE TO RELATED APPLICATIONS

This application is a national phase entry of International Application No. PCT/IB2019/060038, filed Nov. 21, 2019, which claims the benefit of Chinese Application No. 201910661744.0, filed Jul. 22, 2019, the disclosures of which are incorporated by reference herein.

### TECHNICAL FIELD

The disclosure relates to an aluminum alloy for use in tubes for heat exchangers and to tubes produced from the alloy. The tubes may have inner helical grooves or inner straight grooves or a combination of straight and helical grooves. The disclosure also relates to heat exchangers comprising the tubes.

### BACKGROUND

When manufacturing heat transfer tubes for heat exchangers it is important to assure an efficient heat transfer performance of the tube. Heat transfer tubes with alternating grooves on their inner surfaces may cooperate to enhance turbulence of fluid heat transfer mediums, such as water, delivered within the tube. This turbulence may increase the fluid mixing close to the inner tube surface to reduce or virtually eliminate the boundary layer build-up of the fluid medium close to the inner surface of the tube which may otherwise increase the heat transfer resistance of the tube. The grooves and ridges may also provide extra surface area for additional heat exchange.

Helically grooved tubes (hereinafter HG tube) may be used in heat exchangers in domestic and commercial air conditioners, heat pump water heaters, etc. The alloy used for HG tubes may be AA3003 or AA3003 with zinc arc spray coating for better corrosion resistance. There is a demand for corrosion resistant heat exchangers and so called “long-life” alloys are used in many applications to meet the requirements. Existing long-life alloys, however, cannot be applied to make helically grooved tubes because of the limitation in drawability and tensile strength. Consequently, there is a need for a long-life alloy, which is suitable for making a helically grooved tube.

### SUMMARY

In some embodiments, the disclosure describes an alloy that is suitable for making corrosion resistant tubes for heat exchangers. In particular, the alloy may be suited for making helically grooved tubes due to its mechanical strength and formability in combination with its corrosion resistance properties. Heat transfer tubes are commonly used in equipment, for example, evaporators, condensers, coolers and heaters, used in the automotive and HVAC&R sector. A variety of heat transfer mediums may be used in these applications, including, but not limited to, pure water, a water glycol mixture, any type of refrigerant (such as R-22, R-134a, R-123, R410a etc.), ammonia, petrochemical fluids, and other mixtures.

### BRIEF DESCRIPTION OF THE DRAWINGS

FIG. 1 shows the time to perforation of tubes of an embodiment of alloy A according to the disclosure and tubes made from alloy B with and without a Zn coating.

FIG. 2a shows a cross section of a leaking tube from a tube of alloy B after 7 days of SWAAT testing

FIG. 2b shows a cross section of a non-perforated tube from an alloy A according to the disclosure after 118 days of SWAAT testing

FIG. 3 shows an embodiment of a helical grooving tool box

FIG. 4 shows the mechanical properties of an extruded tube according to an embodiment of the disclosure and a tube made from alloy B.

FIG. 5 shows the mechanical properties of a helically grooved tube according to the an embodiment of the disclosure after in-line anneal compared to a tube made from alloy B.

FIG. 6 shows an outline of an embodiment of a drawing process for a helical grooved tube

### DETAILED DESCRIPTION

In some embodiments, the disclosure describes an alloy, such as the alloy in Table 1, that may be a long-life alloy for making heat exchanger tubes. In some embodiments, the chemical composition comprises 1.0-1.5 wt % Mn, up to 0.1 wt % Mg, preferably 0.08 wt % Mg, up to 0.3 wt % Si: up to 0.3 wt % Fe, up to 0.1 wt % Cu, up to 0.25 wt % Cr, up to 0.1 wt % Ni, up to 0.3 wt % Zn, up to 0.2% Ti, up to 0.2 Zr and unavoidable impurities, each 0.05 wt. % maximum and the total of impurities 0.15 wt. % maximum, balance Aluminum.

In some embodiments, the disclosed alloy may relate to an aluminum alloy comprising 1.0-1.2 wt % Mn, up to 0.1 wt % Mg, or 0.08 wt % Mg, 0.10-0.15 wt % Si: up to 0.3 wt % Fe, up to 0.05 wt % Cu, up to 0.03-0.2 wt % Cr, up to 0.05 wt % Ni, up to 0.2-0.3 wt % Zn, up to 0.1 wt % Ti, up to 0.2 wt % Zr and unavoidable impurities, each 0.05 wt. % maximum and the total of impurities 0.15 wt. % maximum, balance aluminum.

In some embodiments, the disclosure describes an aluminum alloy comprising 1.0-1.1 wt % Mn, up to 0.05 wt % Mg, 0.10-0.15 wt % Si: up to 0.3 wt % Fe, up to 0.05 wt % Cu, 0.05-0.1 wt % Cr, or 0.0 up to 0.05 wt % Ni, 0.2-0.25 wt % Zn, up to 0.05 wt % Ti, up to 0.05 wt % Zr and unavoidable impurities, each 0.05 wt. % maximum and the total of impurities 0.15 wt. % maximum, balance aluminum.

In some embodiments, the disclosure describes an aluminum tube produced from such aluminum alloys, in particular to tubes having an internally grooved surface. The internal grooves may, in some embodiments, have a height of at least 0.05 mm.

The disclosure may also related to a heat exchanger comprising tubes and fins, wherein the tubes are made from the inventive aluminum tubes, where the heat exchanger may be made by inserting the tubes in holes in plates forming the fins of the heat exchanger.

In some embodiments, the heat exchanger may also be a serpentine heat exchanger formed by parallel multiport extruded tubes between which undulating aluminum fins are brazed.

TABLE 1

| | | | | | | | | | | | Others | Others |
|---|---|---|---|---|---|---|---|---|---|---|---|---|
| Elements | Si | Fe | Cu | Mn | Mg | Cr | Ni | Zn | Zr | Ti | Each | Total |
| Alloy A wt % | ≤0.3 | ≤0.3 | ≤0.1 | 1.00-1.50 | <0.1 | ≤0.25 | ≤0.1 | ≤0.3 | 0.2 | ≤0.2 | ≤0.05 | ≤0.15 |

The disclosed alloy may be a combination of carefully selected elements in ranges that may provide properties that may be particularly suitable for heat exchanger tubes with internal grooves.

In some embodiments, Mn may be the main additive element for improving the alloy strength. In some embodiments, the content of Mn may be 1.0-1.2 wt %, more preferably 1.0-1.1 wt %. In some embodiments, this content of Mn may provide enough strength to undergo the helical grooving process and help prevent tube breakage. This amount may also be soft enough such that the force needed to expand the tube may not cause the fins inside the tube to collapse or to bend the tube due to high friction between the fins and the bullet during expansion, which may otherwise impact tube corrosion resistance post brazing.

In some embodiments, Mg may be ≤0.1 wt %, or may be ≤0.08 wt %, or may be ≤0.05 wt % to get good brazing of the heat exchanger with Nocolok flux application.

In some embodiments, Si and Fe may controlled to ≤0.3 wt %, which may each improve the corrosion resistance. The content of Si may be 0.10-0.15 wt %, which may improve the corrosion resistance performance.

In some embodiments, Cr may be added for refining the grain structure and improving alloy strength and corrosion resistance, but may be controlled to ≤0.25 wt %, or to ≤0.05-0.2 wt %, or to ≤0.05-0.1 wt % for good extrudability and good formability during the helical grooving process.

In some embodiments, Cu may be 0.1 wt %, or the Cu content may be 0.05 wt % for good corrosion resistance of the tube.

In some embodiments, Zn may add up to 0.3 wt % and may help with improving pit corrosion resistance, driving corrosion uniform around tube surface. Preferably the content of Zn is 0.1 wt %-0.3 wt %, or 0.2-0.3 wt %, or 0.25-0.3 wt %.

Fe may be controlled to be up to 0.3 wt % Fe. In some embodiments, higher contents of Fe may affect the corrosion resistance negatively. High Fe-containing particles may act as cathodes dissolving anodic surroundings.

Ni may be detrimental to the intergranular corrosion resistance and, in some embodiments, may be limited to ≤0.1 wt %, or ≤0.05 wt %.

In some embodiments, Ti may be used for grain refining but may also be used to improve the corrosion resistance. The Ti content may be limited to ≤0.2 wt %, ≤0.1 wt %, or ≤0.05 wt %.

Zr may be considered positive to corrosion due to a positive effect on the size of intermetallics and may be added up to 0.2 wt % in some embodiments. The formed intermetallic Al3Zr is not known to be active in a corrosive environment and thus not detrimental to the corrosion resistance. If adding more than 0.2 wt % Zr, the alloy cost may be high due to Zr being an expensive element. Alloys comprising >0.2 wt % Zr may also be more difficult to recycle and have a lower formability.

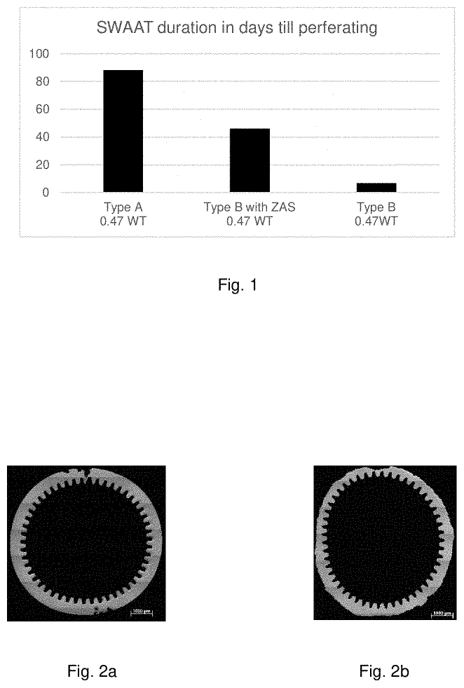

Tests have been made to compare the corrosion resistance of an embodiment of alloy A, according to the disclosure, with an alloy B with slightly higher contents of Si, Fe and Ti, but lower contents of Zn and Cr. The combined content of Zinc, Si and Fe in the alloy according to the disclosure may provide excellent corrosion resistance. Cr may increase the strength of the alloy and compensate to some part for the lost strength due to the lower contents of Si and Fe. As can be seen in FIGS. 1 and 2, showing the SWAAT result from testing of helically grooved tubes of alloy A and B (with and without a Zn coating, “ZAS”), the corrosion resistance of Alloy A is much higher than for alloy B tubes. All non-Zn coated tubes of alloy B leak after only 7 days of exposure.

TABLE 2

| | | | | | | | | | | Other elements, |
|---|---|---|---|---|---|---|---|---|---|---|
| Element | Si | Fe | Cu | Mn | Mg | Cr | Ni | Zn | Ti | each |
| Alloy A | 0.126 | 0.185 | 0.003 | 1.127 | 0.01 | 0.066 | 0.006 | 0.22 | 0.013 | — |
| Alloy B | 0.175 | 0.564 | 0.076 | 1.119 | 0.004 | 0.003 | — | 0.018 | 0.018 | — |

FIG. 2a is a photo of a cross section of the tube made from Alloy B which shows leakage already after 7 days of testing in SWAAT. The mode of corroding is pit corrosion, while in FIG. 2b, a cross section of an Alloy A tube a more uniform corrosion has taken place and the Alloy A tubes leaked only after 118 days SWAAT.

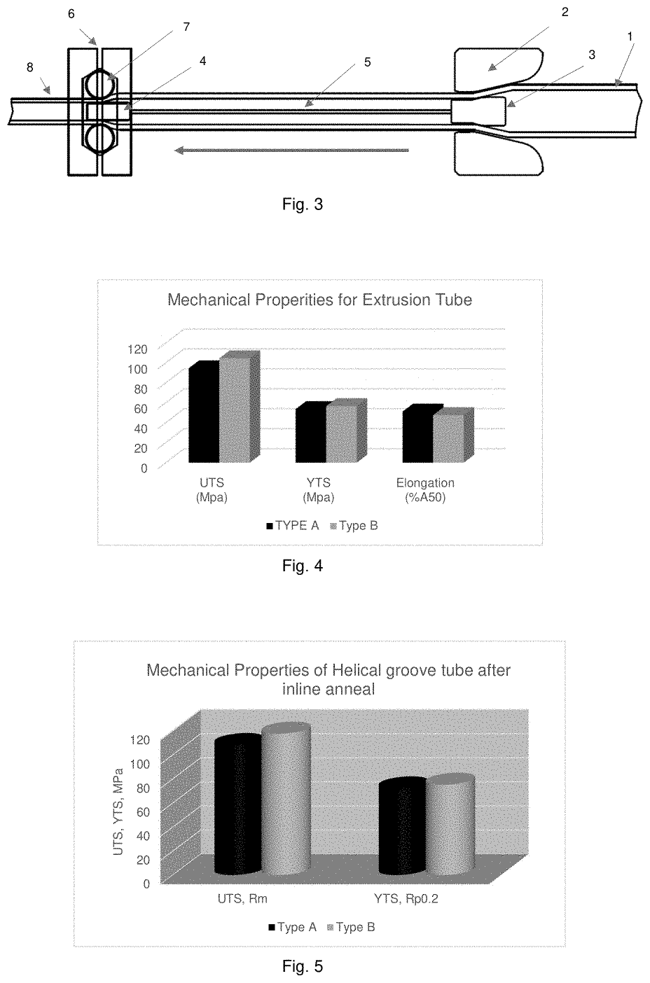

An embodiment of an apparatus for making a helically grooved tube is shown in FIG. 3.

In some embodiments, alloy billets may be extruded to form a base tube (1) in an extrusion press, and the base tubes may be drawn by a continuous drawing machine to a size of tube (8), as shown in FIG. 3. The tubes may pass a drawing station (2) with a fixed plug (3) position, and then to fix helical grooving plug (4) position by a steel shaft (5) connection. The tubes may be drawn by the helical grooving plug (4) for making helical grooves on the inside of the tube without expansion of the tube. The plug, which may be put inside of the tube, may shape the tube to the desired inner diameter. During helical grooving, there may be steel balls (7) surrounding the tube in the gear box 6, and the balls may be driven by a motor that may spin at high speed and press aluminum into the die for helical grooving. The outer diameter may be decided by an assembly dimension of the gear box size and the steel ball diameter, which may rotate surrounding the tube. To pass the grooving process, it is helpful that the alloy have a good formability and a high strength.

After helical grooving, the tube (1) may have a ball mark and may need to pass a sink drawing unit comprising a drawing die and a drawing plug for smoothing the outer surface and obtain the final tube size.

FIG. 4 shows the tensile strength of tubes tested according to EN 755-2.

The tensile strength of the HG tubes made from alloy A according to the disclosure may be lower than for the tubes made from alloy B, but the strength may be good enough to ensure a reliable manufacturing by the helical grooving process.

FIG. 5 shows the mechanical properties of an embodiment of the helical tube after inline anneal by heating tube to 450 to 550 degrees C. during drawing with 200 m/min drawing speed.

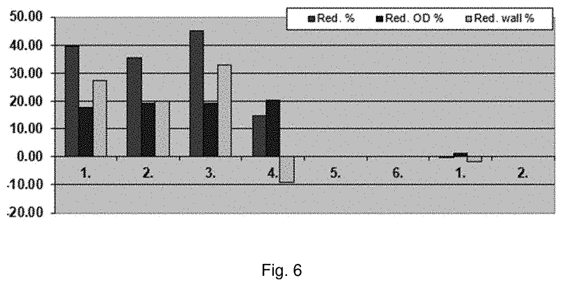

The reduction of the tube dimensions during the drawing after different number of passes through the drawing station is shown in FIG. 6. The tube size of the tested tubes is: outer diameter (OD)=7 mm, wall thickness (WT)=0.47 mm, fin height (FH)=0.25 mm and the number of grooves (FN)=50. The drawing test is outlined in FIG. 6. The pillars in the graph shows the % reduction of the dimensions in each draw. The total drawing deformation of the tubes was 81%.

Based on the drawability of a tube made from the alloy according to the disclosure, in some embodiments, the outer diameter may be from 5 to 10 mm, wall thickness 0.35-0.7 mm, fin height max 0.35 mm and fin numbers may be max 50.

In some embodiments, a heat exchanger with enhanced heat transfer performance may be produced by forming internal grooves on the inside of tubes that are to be inserted into an insertion hole opened in an aluminum heat dissipating fin (also called fin and tube type heat exchanger) and then inserting a mandrel for expanding the tube having an outer diameter larger than the inner diameter of the heat transfer tube, and the outer peripheral surface of the heat transfer tube may be in close contact with the insertion hole of the aluminum heat dissipating fin.

The alloy according to the disclosure may also be used to produce regular round tubes and to extrude micro-channel flat tubes (MPEs). In some embodiments, dimensions for smooth tubes may be diameters from 5-30 mm and wall thicknesses above 0.3 mm. In some embodiments, dimensions for MPEs may be widths down to 8 mm, with minimum heights of 1 mm, and wall thicknesses above 0.15 mm.

1. An aluminum alloy comprising
0-1.5 weight percent manganese (Mn);
up to 0.1 weight percent magnesium (Mg);
up to 0.3 weight percent silicon (Si);
up to 0.3 weight percent iron (Fe);
up to 0.1 weight percent copper (Cu);
up to 0.25 weight percent chromium (Cr);
up to 0.1 weight percent nickel (Ni);
up to 0.3 weight percent zinc (Zn);
up to 0.1 weight percent titanium (Ti);
up to 0.2 weight percent zirconium (Zr); and
impurities, each impurity no more than 0.05 weight percent and wherein a total of impurities is no more than 0.15 weight percent,
balance aluminum (Al).

2. The aluminum alloy according to claim 1, wherein the aluminum alloy comprises less than 0.08 weight percent Mg.

3. The aluminum alloy according to claim 1, wherein the aluminum alloy comprises:
1.0-1.2 weight percent Mn;
0.10-0.15 weight percent Si;
up to 0.05 weight percent Cu;
up to 0.03-0.2 weight percent Cr;
up to 0.05 weight percent Ni;
up to 0.2-0.3 weight percent Zn;
and
impurities, each impurity no more than 0.05 weight percent and wherein the total of impurities is no more than 0.15 weight percent,
balance Al.

4. The aluminum alloy according to claim 1, wherein the aluminum alloy comprises:
1.0-1.1 weight percent Mn;
up to 0.05 weight percent Mg;
0.10-0.15 weight percent Si;
up to 0.05 weight percent Cu;
0.05-0.1 weight percent Cr;
up to 0.05 weight percent Ni;
0.2-0.25 weight percent Zn;
up to 0.05 weight percent Ti;
up to 0.05 weight percent Zr; and
impurities, each no more than 0.05 weight percent and the total of impurities is no more than 0.15 weight percent,
balance Al.

5. An aluminum tube produced from an aluminum alloy according to claim 1.

6. The aluminum tube according to claim 5, the aluminum tube having an inner grooved surface.

7. The aluminum tube according to claim 6, wherein inner grooves of the inner grooved surface have a height of at least 0.05 mm.

8. A heat exchanger comprising:
one more tubes an aluminum alloy comprising:
1.0-1.5 weight percent manganese (Mn);
up to 0.1 weight percent magnesium (Mg);
up to 0.3 weight percent silicon (Si);
up to 0.3 weight percent iron (Fe);
up to 0.1 weight percent copper (Cu);
up to 0.25 weight percent chromium (Cr);
up to 0.1 weight percent nickel (Ni);
up to 0.3 weight percent zinc (Zn);
up to 0.1 weight percent titanium (Ti);
up to 0.2 weight percent zirconium (Zr);
impurities, each impurity no more than 0.05 weight percent and wherein a total of impurities is no more than 0.15 weight percent, and
balance aluminum (Al); and
one or more fins.

9. The heat exchanger according to claim 8, wherein the one or more tubes are formed by multiport extruded tubes.

10. The heat exchanger according to claim 8, wherein the one or more tubes are disposed in holes in plates forming the one or more fins of the heat exchanger.

11. The aluminum alloy according to claim 2, wherein the aluminum alloy comprises:
1.0-1.2 weight percent Mn;
0.10-0.15 weight percent Si;
up to 0.05 weight percent Cu;
up to 0.03-0.2 weight percent Cr;
up to 0.05 weight percent Ni;
up to 0.2-0.3 weight percent Zn; and
impurities, each impurity no more than 0.05 weight percent and wherein the total of impurities is no more than 0.15 weight percent,
balance Al.

12. An aluminum tube produced from an aluminum alloy according to claim 2.

13. An aluminum tube produced from an aluminum alloy according to claim 3.

14. An aluminum tube produced from an aluminum alloy according to claim 4.
